(19) United States
(12) Patent Application Publication
(10) Pub. No.: US 2004/0202854 A1
(43) Pub. Date: Oct. 14, 2004

(54) Non-slip mat

(76) Inventor: John J. Esparza, Santa Barbara, CA (US)

Correspondence Address: Roland H. Shuberet, Post Office Box 2339, Reston, VA, 20195-0339, US

(21) Appl. No.: 10/410,641

(22) Filed: Apr. 9, 2003

(51) Int. Cl. B32B 5/18; D21H 11/00; B32B 3/00; B32B 3/26; B32B 5/24; D21H 13/00

(52) U.S. Cl. 428/314.4; 428/304.4; 428/315.9; 428/311.51

(57) ABSTRACT

An anti-slip mat includes three layers, a top and a bottom layer of an expanded, closed cell elastomer and a center layer of a strong, non-stretching and waterproof fabric. The mat layers are held in place, one on top of another, by a fabric binding extending around the perimeter of the map and secured by stitching.

### BACKGROUND OF THE INVENTION

1. Technical Field

This invention relates to a non-slip, safety and surface protection mat.

More particularly, this invention relates to a durable and washable mat of layered construction that provides a high degree of resistance to lateral slip while also protecting the surface on which it is placed.

2. Description of Related Art

A wide variety of rubber sheet materials have been and are being used for anti-slip or anti-fatigue matting. Such sheet materials frequently comprise expanded closed cell rubber sheeting that is used either alone as a single sheet or with a backing or reinforcing layer bonded to the sheeting to form a multi-layer mat.

The patent literature discloses a number of multi-layer mats, and one such mat is shown in U.S. Pat. No. 6,159,576. The two-layer floor mat described in that patent includes tufts of nylon monofilament set into a foam rubber backing layer. Another multi-layer floor mat is shown in the Kerr patent, U.S. Pat. No. 5,902,662. The mat disclosed by Kerr includes pile yarns of cotton, nylon or other suitable material tufted through a fabric carrier layer with the bottom of the tufts adhered to a rubber backing sheet. Other exemplary multi-layer mats are described in U.S. Pat. Nos. 6,296,919 and 5,683,780.

Despite the large variety of mats known and used in the art, none offer the combination of simplicity, economy, ease of maintenance and versatility that is obtained in the anti-slip mat of this invention.

### SUMMARY OF THE INVENTION

The anti-slip mat of this invention consists of three non-laminated layers, a top and a bottom layer of expanded, closed cell rubber, and a middle layer of a fabric having a high coefficient of friction relative to the top and bottom layers. The three layers are secured together by means of a fabric binding extending around the perimeter of the mat and held in place by stitching.

Hence, it is an object of this invention to provide a multi-purpose, anti-slip mat.

It is another object of this invention to provide an anti-slip mat that is economical to produce, durable, easy to clean and versatile in use.

Other objects and advantages of this invention will become evident from the following disclosure and description of certain preferred embodiments.

### BRIEF DESCRIPTION OF THE DRAWINGS

FIG. 1 is a plan view of a typical anti-slip mat in accordance with this invention;

FIG. 2 is a partial cross-sectional view of the mat of FIG. 1;

FIG. 3 is an edge detail view of the mat of FIG. 1; and

FIG. 4 is an enlarged detail view of a portion of the top layer of the mat shown in FIG. 1.

### DESCRIPTION OF PREFERRED EMBODIMENTS OF THE INVENTION

The anti-slip mat of this invention provides a safe, secure and protective work surface for personnel, equipment, power tools, ladders and the like. It will be described with reference to the Figures in which a plan view of a typical mat is shown at 10.

Mat 10 consists of three separate and physically distinct layers, a top layer 12, a bottom layer 14, and an intermediate, or center, layer 16. Top layer 12 and bottom layer 14 each consist of a sheet of expanded, closed cell elastomer such as sponge or crepe rubber. Particularly preferred rubber sheets are those of the kind known commercially as underlayments, or rug pads, for use under rugs that are placed over hard floors. Those rubber sheets can be formulated from a variety of elastomers, styrene-butadiene rubber (SBR), for example, depending upon the specific properties desired. Closed cell rubber sheets of the kind used as top layer 12 and bottom layer 14 are typically manufactured by extruding an elastomer containing a blowing agent through a die which determines the thickness of the resulting sheet. The extruded stock travels through a vulcanizing chamber that causes the blowing agent to decompose and to produce an inert gas which expands to form closed, gas filled cells.

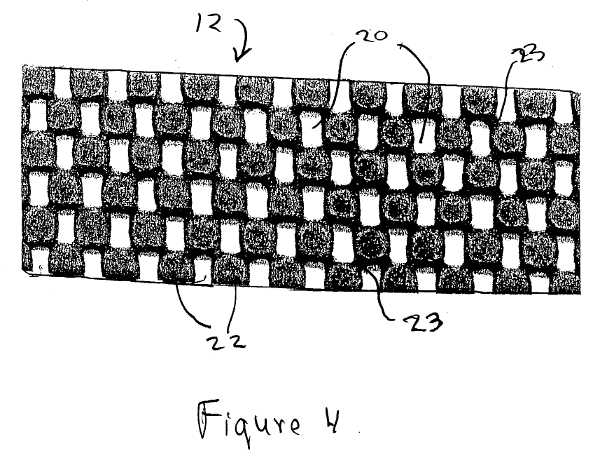

Top layer 12 and bottom layer 14 may be identical in composition and, in many instances, that arrangement is preferred. Each layer may range in thickness from about 1/16 to about ¼ inch in thickness, resulting in the total thickness of mat 10 being from about ⅛ to about ½ inches. It has been found that a thickness of approximately ⅛ inch for each of layers 12 and 14 works well in most applications. As is shown in FIG. 4, it is preferred that the rubber sheets making up layers 12 and 14 have openings 20 located in a regular pattern that is defined by the placement of rubber masses 22 which may be joined by connecting strips 23 to form a basket weave appearance. Those openings enhance the anti-slip character of the mat by allowing water, other liquids and solid debris that might be spilled on the mat to drain or sift through the layer and not collect on the surface.

Intermediate, or center, layer 16 consists of a strong, non-stretching fabric which may be canvas, but more suitably is a cloth that is tightly woven from a synthetic fiber such as nylon or polypropylene. It has been found that 400 to 1000 denier nylon fabric of the kind often used to manufacture packs and luggage is particularly suitable. It is also preferred that the fabric of layer 16 be water repellant or water proofed. Water repellency of fabric layer 16 may be obtained by using a fabric 16 that has been coated on at least one side with polyurethane or similar material and water proofing may include a fused backing of a polyester resin or similar agent.

Fabric layer 16 performs multiple functions. As pressure is applied to the mat, the expanded rubber of the top and bottom mat layers tends to adhere to the center fabric layer thereby imparting a high resistance to lateral shear, or the movement of one layer relative to another. More importantly, the strong fabric prevents tearing or ripping of the relatively weak rubber layers as shear forces are applied to the mat surface. The water resistant character of fabric layer 16 prevents liquid or small particulates from penetrating through the mat, thus providing a high level of protection to the surface on which the mat is placed.

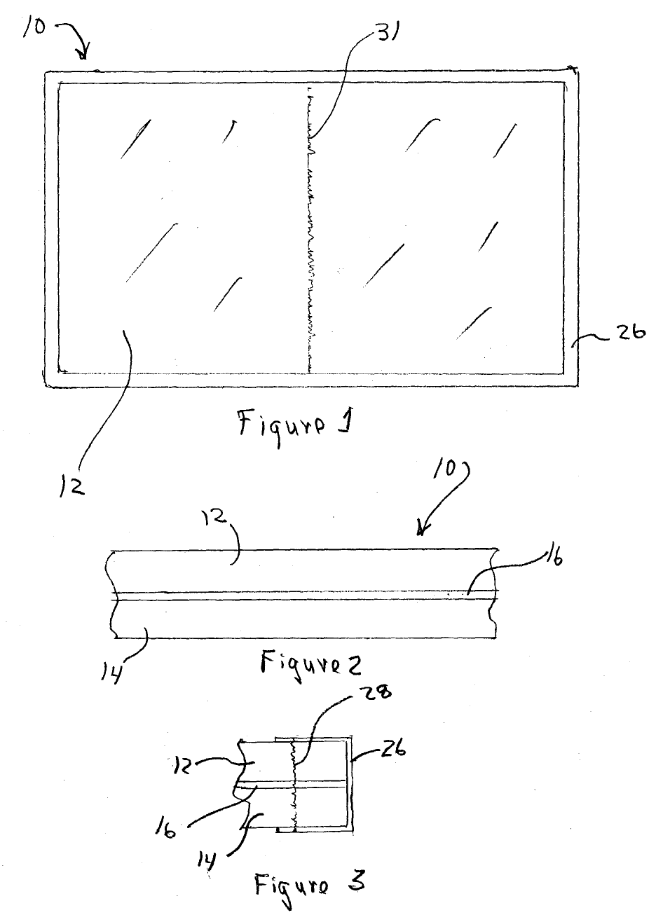

The three mat layers, the two expanded rubber sheets on the top and bottom of the mat, and the center fabric layer, are held in place one relative to another by a securing means 26 that preferably comprises a fabric binding strip extending around the perimeter of the mat. Binding 26 is preferably made from a high strength synthetic fabric such as nylon, and is best shown in the edge detail view of FIG. 3. Binding 26 is folded over the mat edge and is secured by a row of stitching 28 that extends through the top fold of the binding strip, through the three mat layers, and through the bottom fold of the binding strip. It may be advantageous with larger mats, greater than a few square feet in area, to add an occasional line of stitching 31 (FIG. 1) from one mat edge to another through the three mat layers depending upon the use to which the mat is put. The lines of stitching need be no closer together than 1 to 2 feet.

The structure of mat 10 allows it to be easily cleaned as the separate mat layers allow foreign matter to be easily flushed out. Smaller mats are completely machine washable. The mats dry very rapidly because the closed cell structure of the top and bottom expanded rubber layers does not absorb water or other liquids, and the center fabric layer is water resistant or water proof.

The mats have proven to be extremely useful in a variety of applications. For example, ladders are prone to slipping when the legs are set upon a smooth or a hard surface such as a tile floor. That tendency to slip becomes more pronounced if the rubber pads on the ends of the ladder legs are dirty or hardened with wear and age. Use of an anti-slip mat of this invention under the ladder legs essentially eliminates slippage, and protects the underlying surface from marking or scratching. A mat placed under a power appliance such as a saw, or router, or sander absorbs much of the vibration produced by the appliance and prevents the appliance from “walking” or moving during use. The mat may also be used as a tool or material rest on a sloping surface, such as a roof, to keep the tools from slipping off. It has also been found useful as a fender cover when working on a vehicle, as a veterinarian's examining table cover when treating small animals, and for a host of similar uses.

As may be appreciated from the foregoing description, this invention provides a novel, practical and economical anti-slip mat. It has been described in relation to preferred embodiments thereof that are illustrated in the drawing Figures. It is to be understood that variations and modifications of the invention, other than those specifically described, will be apparent to those skilled in the art and are included within the scope of the invention as defined by the following claims.

I claim:

1. A non-slip mat consisting of three layers, a top layer comprising a sheet of expanded, closed cell elastomer, a bottom layer comprising a sheet of expanded, closed cell elastomer, and an intermediate layer comprising a non-stretching fabric, said three layers held in place by securing means extending around the perimeter of the mat.

2. The non-slip mat of claim 1 wherein said sheet of elastomer comprising said top layer has the same composition as does said bottom layer.

3. The non-slip mat of claim 1 wherein the fabric making up said intermediate layer is a cloth woven from a synthetic fiber.

4. The non-slip mat of claim 3 wherein said cloth making up the intermediate layer is water proof.

5. The non-slip mat of claim 3 wherein said cloth making up the intermediate layer is a nylon fabric.

6. The non-slip mat of claim 5 wherein said nylon fabric is woven from 400 to 1000 denier fibers.

7. The non-slip mat of claim 1 wherein said top layer is an expanded rubber sheet having a thickness in the range of about one-sixteenth to one-fourth inch.

8. The non-slip mat of claim 7 wherein said rubber sheet has multiple perforations therethrough.

9. The non-slip mat of claim 8 wherein said perforations form a regular pattern.

10. The non-slip mat of claim 1 wherein said bottom layer is an expanded rubber sheet having a thickness in the range of about one-sixteenth to one-fourth inch.

11. The non-slip mat of claim 10 wherein said rubber sheet has multiple perforations therethrough.

12. The non-slip mat of claim 11 wherein said perforations form a regular pattern.

13. The non-slip mat of claim 1 wherein said securing means comprises a fabric binding having a fold on the top of the mat, crossing the mat edge, and having a fold on the bottom of the mat.

14. The non-slip mat of claim 13 wherein said fabric binding is secured by stitching that extends through the top fold of the binding, through the three mat layers, and through the bottom fold of the binding.

15. The non-slip mat of claim 1 including at least one line of stitching through the three mat layers, said line of stitching extending from one mat edge to another.

16. An non-slip mat consisting of three separate layers, a top layer consisting of a sheet of expanded, closed cell rubber having a thickness in the range of about one-sixteenth to one-fourth inch, a center intermediate layer consisting of a tightly woven nylon fabric, and a bottom layer consisting of a sheet of expanded, closed cell rubber having a thickness in the range of about one-sixteenth to one-fourth inch, said three layers held in place, one atop another, by a fabric binding extending around the perimeter of the mat.

17. The non-slip mat of claim 16 wherein said nylon fabric is waterproof.
